(19) United States
(12) Patent Application Publication
(10) Pub. No.: US 2025/0061140 A1
(43) Pub. Date: Feb. 20, 2025

(54) SYSTEMS AND METHODS FOR ENHANCING SEARCH USING SEMANTIC SEARCH RESULTS

(71) Applicant: CS Disco, Inc., Austin, TX (US)

(72) Inventors: Liad Levinson, Austin, TX (US); Adam Peterson, Austin, TX (US)

(21) Appl. No.: 18/809,070

(22) Filed: Aug. 19, 2024

Related U.S. Application Data
(60) Provisional application No. 63/520,266, filed on Aug. 17, 2023.

(51) Int. Cl. G06F 16/33; G06F 16/332; G06F 40/237

(52) U.S. Cl. CPC G06F 16/3344; G06F 16/3326; G06F 40/237

(57) ABSTRACT

Embodiments of the present disclosure provide systems and methods for enhancing search using semantic search results. A semantic search engine performs a semantic search to identify documents semantically related to a search query. A search query to perform a second type of search is received. The second type of search is scoped to content identified in the previous semantic search.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records but reserves all other copyright rights whatsoever.

### RELATED APPLICATIONS

This application claims the benefit of priority under 35 U.S.C. § 119(e) of U.S. Provisional Patent Application 63/520,266, entitled “Systems and Methods for Enhancing Search using Semantic Search Results,” filed Aug. 17, 2023, which is hereby fully incorporated by reference herein.

### TECHNICAL FIELD

This disclosure relates generally to searching electronic documents. Even more particularly, embodiments of the present application relate to enhancing searching of large bodies of potentially complex documents using the results of a semantic search.

### BACKGROUND

In the modern world, many documents that are being created, utilized, and maintained are in electronic format. Several situations commonly arise that require an analysis or identification of certain relevant electronic documents from a relatively large pool of available electronic documents. These situations are generally referred to as information retrieval or search problems. These types of search problems crop up in a wide variety of contexts. For example, in litigation, an attorneys may have to search through a large volume of documents provided by their client and received during discovery to find information needed to

To illustrate in more detail, parties to litigation typically must share relevant evidence with opposing counsel through the discovery process. In many cases, each party makes a reasonable search of their records based on some set of terms or keywords and produces the results of the search to the other party. Discovery thus typically involves the gathering of potentially relevant materials, much of it digital, and then reviewing such materials to determine what to be shared with opposite parties. Additionally, during the litigation, the lawyers must continually review those documents produced both by their own client and by the opposing party to locate documents relevant to the case at hand. Litigation thus represents a microcosm of a more general problem raised by the high volume of electronic documents present in a variety of contexts. Namely, how large volume of electronic documents can be understood, reviewed, or searched in order that documents relevant to a particular topic or user's interest may be located.

Document analysis systems help resolve these problems. A document analysis system is a computer-implemented system that allows users to search, analyze, review or navigate information in a corpus to locate electronically stored information of interest. Document analysis systems are often tailored to specific contexts, such as electronic discovery, academic research, etc. E-discovery systems, for example, include tools to allow attorneys to search documents for review, exhaustively tag the documents, and use the tags to determine whether and how to produce documents, thus assisting in review for production. An attorney may also use a document analysis system during investigation, where the attorney determines the facts of a case and finds evidence for or against those facts.

Document analysis systems typically support lexical searching of documents. In a common scenario, a user of a document analysis system submits a query to the document analysis system to search a corpus of documents and the search engine of the document analysis system selects a set of results from the corpus based on the terms of the search query. The terms of search queries usually specify words, terms, phrases, logical relationships, metadata fields to be searched, synonyms, stemming variations, etc. The search engine performs a lexical search on metadata fields and, in some systems, document content for literal matches of words, terms, phrases or variants to identify documents and returns the documents that meet the logical constraints specified in the search.

With lexical search, the meaning or intent of the query can be lost. This can result in the search engine missing documents that meet the intent behind the query but do not match the words in the query. On the other hand, a lexical search may also return many documents that match the search terms but are not relevant to the intent behind the query.

Some document management systems also support other types of searches, such as semantic search, which attempts to understand the intent and contextual meaning behind a search query to provide more relevant results. Semantic searching is more time-consuming and computationally expensive than lexical searching and can produce less accurate results than lexical searching when the semantic search query does not contain enough context.

In document analysis systems that support multiple types of searches, each search type (e.g., lexical, semantic, etc.) is treated as a different problem domain and considered independently. If, for example, a user wishes to run a lexical search and a semantic search, they use a lexical search tool for the lexical search and a semantic search tool for the semantic search. If a user is interested in documents that match different types of searches, the user must compare the search results from the different types of searches. For example, if the user is interested in documents that both have specific lexical characteristics and semantic meaning, it is left to the user to determine which documents are of interest by reviewing both lexical search results and the independent semantic search results. Document analysis tools do not provide a way to seamlessly change between search types.

What is desired, therefore, are improved systems and methods for searching large bodies of potentially complex documents.

### SUMMARY

Embodiments of the present disclosure provide systems and methods for enhancing search using semantic search results. One embodiment includes a computer-implemented method for searching electronic documents. The method comprises receiving a semantic search query from a user to semantically search a document corpus; servicing the semantic search query to return a first search result, the first search result identifying first documents from the document corpus that are determined to be semantically relevant to the semantic search query; receiving a second search query from the user to perform a second type of search the document corpus; and servicing the second search query to perform the second type of search scoped to the first documents to return a second search result. The second type of search may be a lexical search, a search performed by generative AI, or another type of search. In some embodiments, the second search is scoped to the semantic search results based on a request by a user. In other embodiments the second search is scoped automatically.

Another embodiment includes a non-transitory, computer-readable medium storing thereon document analysis code executable by a processor, the document analysis code comprising instructions for receiving a semantic search query from a user to semantically search a document corpus; servicing the semantic search query to return a first search result, the first search result identifying first documents from the document corpus that are determined to be semantically relevant to the semantic search query; receiving a second search query from the user to perform a second type of search the document corpus; and servicing the second search query to perform the second type of search scoped to the first documents to return a second search result. The second type of search may be a lexical search, a search performed by generative AI, or another type of search. In some embodiments, the second search is scoped to the semantic search results based on a request by a user. In other embodiments the second search is scoped automatically.

Another embodiment provides a computer system for enhanced search. The computer system comprises a storage storing a plurality of snippets and an embedding store. Each of the plurality of snippets can comprise snippet text extracted from a document in a document corpus and a reference to the document from which the snippet text of that snippet was extracted. The embedding store includes a vector index of the plurality of snippets. The computer system further comprises a processor, a semantic search engine executable to perform semantic searching of the document corpus using the vector index, a lexical search engine executable to perform lexical searching of the document corpus, and a user interface. The user interface is executable to scope lexical searches by the lexical search engine to documents identified in semantic search results from the semantic search engine.

According to one embodiment, the semantic search engine is executable to: search the vector index using an embedded query string from a first search input to identify, from the plurality of snippets, semantically relevant snippets that are semantically relevant to the first search input; and return a corresponding semantic search result to the user interface, the corresponding semantic search result comprising document identifiers from the semantically relevant snippets, the document identifiers from the semantically relevant snippets identifying documents from the document corpus. The user interface may be executable to generate a lexical search request to the lexical search engine to perform a corresponding lexical search, the lexical search request comprising search criteria input by a user and the document identifiers from the semantically relevant snippets to scope the corresponding lexical search to the documents identified by the document identifiers from the semantically relevant snippets.

According to one embodiment, the user interface is executable to display a semantic search result to the user and receive, based on a user interaction with the user interface, an indication from the user to scope a lexical search to the documents identified by the semantically relevant snippets. In an even more particular embodiment, the indication to scope the lexical search comprises a selection of one or more citations from the plurality of citations, wherein each of the one or more citations corresponds to one of semantically relevant snippets. In another example embodiment, the user interface automatically scopes the lexical search to the documents identified by the document identifiers from the semantically relevant snippets.

Embodiments may apply retrieval augmented generation (RAG). According to one embodiment, servicing a semantic search query comprises sending a request to a large language model where the request comprises an input query string—for example, an input query string that was used in a semantic search. Accordingly, embodiments may receive generative text generated by the large language model in response to the request. The generative text may be included with the semantic search results. According to one embodiment, the request to the large language model includes context to constrain the large language model to providing a response in the context of results from the semantic search.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a document analysis system.

FIG. 2 is a diagrammatic representation of one embodiment of a request and response flow.

FIG. 3 is a diagrammatic representation of another embodiment of a document analysis system.

FIG. 4 is a diagrammatic representation of another embodiment of a request and response flow.

FIG. 5A, FIG. 5B, FIG. 5C, FIG. 5D and FIG. 5E depict portions of one embodiment of a user interface.

FIG. 6 is a diagrammatic representation of another embodiment of a request and response flow.

FIG. 7 is a diagrammatic representation of one embodiment of a distributed network environment.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and specific examples, while indicating the preferred embodiments, are given by way of illustration only and not by way of limitation. Descriptions of known programming techniques, computer software, hardware, operating platforms, and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Embodiments of the present disclosure provide systems and methods for integrating different types of information retrieval to enhance search results. For example, semantic search can be used to enhance other types of searches, such as lexical search. Users can seamlessly switch between the different types of searches with the document analysis system retaining a scope based on prior search results. When a search is scoped, the search results are limited to documents within the scope either by, for example, the search engine only searching within the scope of the search or the search engine filtering results to exclude documents outside the scope of the search, depending on implementation.

According to one embodiment, a document analysis system can provide an interface that allows a user to run multiple types of searches (e.g., non-semantic search, semantic search, or other types of searches) or workflows that run multiple types of searches. The search results from a search can be used to scope a next search (or other subsequent search), either automatically or based on user selection. For example, the results of a semantic search can be used to scope a subsequent non-semantic search. In an even more particular embodiment, a non-semantic search, such as a lexical search, can be constrained to the documents that appear in the results of a prior semantic search. Embodiments of the present disclosure allow a user or system to switch between search types while maintaining context from a prior search, even if the prior search was of a different type. Embodiments can increase the relevancy of a search by limiting the search to a narrower context determined from the results of a semantic search.

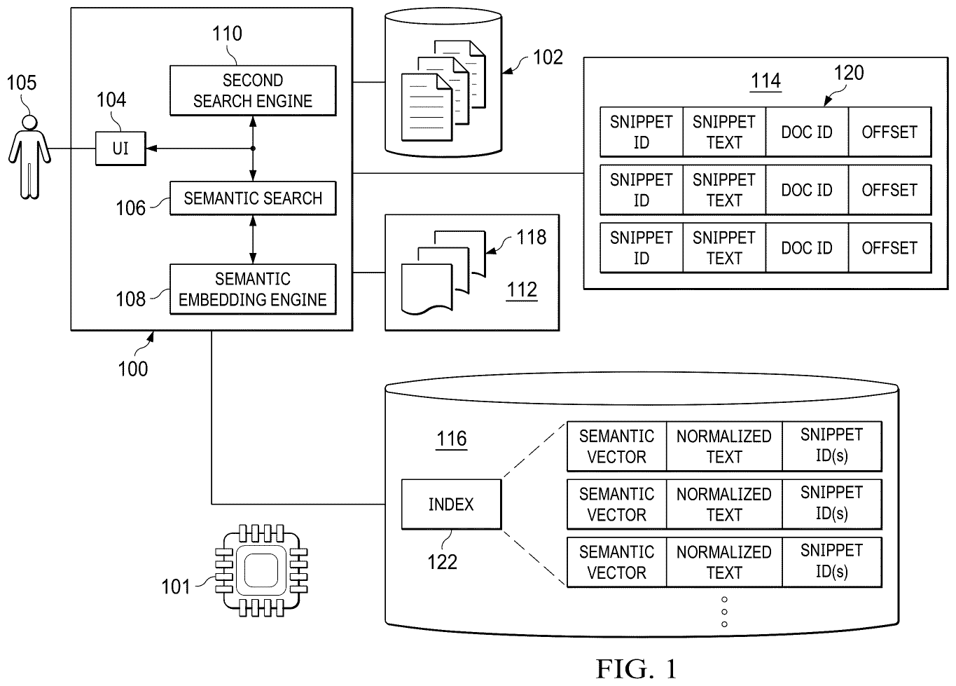

FIG. 1 is a diagrammatic representation of one embodiment of a document analysis system 100. Document analysis system 100 executes on a processor 101, which, in some embodiments, comprises a plurality of processors of a plurality of computers that execute code to provide a document analysis system. The code is embodied, in some embodiments, on a non-transitory, computer readable medium.

Document analysis system 100 supports various types of search technologies for searching a large corpus of documents (document corpus 102). In some embodiments, document corpus 102 includes documents stored on a variety of storage technologies, including across heterogeneous storage technologies (e.g., stored on remote or local databases, remote or local file systems, cloud stores or other storage technologies). Documents in document corpus 102 are assigned unique document identifiers in document analysis system 100.

In the embodiment illustrated, document analysis system 100 includes a user interface 104 through which a user 105 can interact with the system, a semantic search engine 106, a semantic embedding engine 108, and a second search engine 110. According to one embodiment, second search engine 110 performs a different type of search from semantic search engine 106. For example, in one embodiment, second search engine 110 is a lexical search engine that performs a lexical search of documents in corpus 102.

User interface 104 allows user 105 to submit search queries according to the supported search types. Document analysis system 100 can service new queries in the context of prior searches. For example, document analysis system 100 may constrain a lexical search to the results of the semantic search. Thus, iterative searches may be performed in the context of prior searches.

Document analysis system 100 includes a text store 112, a snippet store 114, and an embedding store 116 for storing data related to searching document corpus 102. Each of text store 112, snippet store 114, and embedding store 116 comprises a file system, a database, or other storage technologies or combinations thereof. While illustrated separately, two or more of text store 112, snippet store 114, or embedding store 116 may represent portions of the same data store.

The text of searchable documents from document corpus 102 is stored in document analysis system 100 as index text 118 for the documents. According to one embodiment, the index text 118 for a document comprises a character array of characters from the document—for example, as a single dimensional character array in one embodiment.

To support semantic search, the documents from document corpus 102 may be semantically embedded as document text vectors that represent the document text for semantic searching. More particularly, the documents from document corpus 102 may be broken down into more manageable chunks of text, referred to herein as original text chunks, and the original text chunks semantically embedded as document text vectors. As discussed below, the process of semantically embedding an original text chunk may involve normalizing the original text chunk and semantically embedding the normalized text chunk as the document text vector representing the text chunk.

According to one embodiment, each of the original text chunks associated with a document is a sequence of characters within the index text 118 of a document. In an even more particular embodiment, an original text chunk is a single dimension aware sequence of characters within the index text 118 of a document. According to one embodiment, an original text chunk has a start offset and end offset within the character array of the index text 118 of a document. In some embodiments, the original text chunks follow a set of delineation rules, such as, but not limited to junk text is excluded, punctuation is preserved, capitalization is preserved. The amount of text in an original text chunk will depend on the chunking rules applied. According to one embodiment, the documents from document corpus 102 are chunked into defined grammatical units, such as sentences.

The original text chunks are stored as snippets 120 in snippet store 114. According to one embodiment, a snippet 120 comprises an original text chunk (snippet text), a document ID of a document from document corpus 102, and an offset in a document coordinate system indicating the location of the snippet text in the document (that is, the location of the snippet text in the document having the document ID with which the snippet is associated). A snippet may thus be an original text chunk in the context of a document. Each snippet 120 can be assigned a unique id according to one embodiment.

The snippet texts—that is, the original text chunks—are semantically embedded as document text vectors. Various text embedding models known or developed in the art can be used to semantically embed a text chunk as a document text vector for semantic search. According to one embodiment, a multi-qa-mpnet-base-dot-v1 model is used to generate the text embeddings.

As will be appreciated, semantic embedding may involve text normalization, such as, but not limited to removing white space, removing email line breaks, etc. Thus, according to one embodiment, the embedding process may normalize the original text chunks from snippets 120 as normalized text chunks for embedding as the document text vectors. In some cases, multiple original text chunks from the same document or across documents normalize to the same normalized text chunk (e.g., the same normalized sentence) and thus the same semantic embedding (the same document text vector).

Embedding store 116 comprises a vector index 122 of snippets that associates the semantically embedded text chunks—that is, the document text vectors—with snippets. In a more particular embodiment, index 122 maps the document text vectors to normalized text chunks from which the document text vectors were generated and the snippets 120 from snippet store 114 that map to the normalized text chunks. Because the snippet text in multiple snippets may map to the same normalized text and hence semantic vector, multiple snippets 120 may map to the same normalized text chunk and document text vector in index 122.

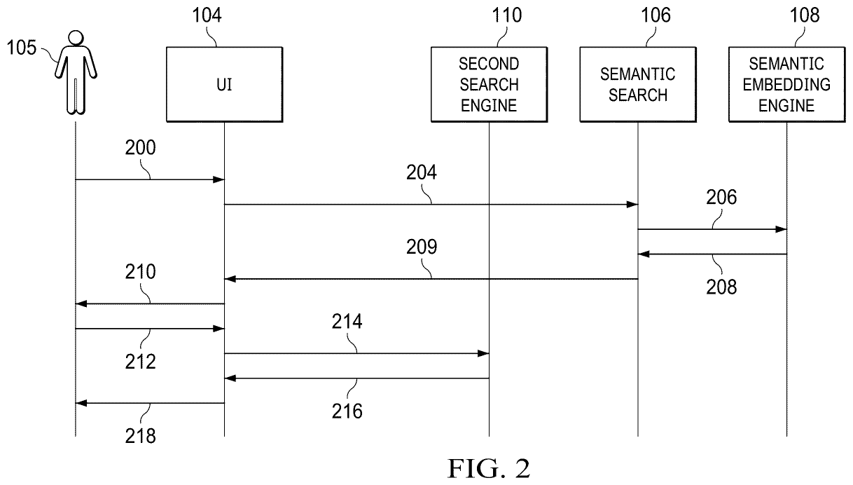

In some embodiments, one or more of the components of document analysis system 100 may be provided by a different system or a third party. Further, document analysis system 100 may include additional or alternative services. For example, document analysis system 100 may include various services to orchestrate searches and reviews of results. Thus, for example, a request illustrated as flowing from one component to another in FIG. 2 may be processed and conditioned by one or more intermediate services between the components.

Turning to FIG. 2, one embodiment of a flow in document analysis system 100 is illustrated. UI 104 receives a semantic search query 200 (e.g., a natural language search query) that includes an input string for semantic search. Document analysis system 100 services the query 200 to return a semantic search result 209 that identifies documents from document corpus 102 that are semantically relevant to the semantic search query. A subsequent search of a second type, such as a lexical search, may be scoped based on semantic search result 209.

Semantic search query 200 includes an input string input by user 105. User interface 104 sends a search request 204 to semantic search engine 106 that includes the input string. Semantic search engine 106 sends a request 206 to semantic embedding engine 108 to embed the user input string. Semantic embedding engine 108 semantically embeds the input string as a semantic vector. The semantic vector that represents the input string may be referred to as a query vector. According to one embodiment, semantic embedding engine 108 embeds the input string in the same way the original text chunks were embedded, including normalizing the input string for embedding in the same manner as the original chunks were normalized for embedding. Semantic embedding engine 108 returns a response 208 to semantic search engine 106 that includes the query vector (that is, the semantically embedded (normalized) input string).

Semantic search engine 106 performs a semantic search of index 122 using the query vector to identify semantically relevant content from index 122. According to one embodiment, semantic search engine 106 supports the approximate matching of text chunks (e.g., normalized text chunks) that enables the semantics to be found with related meaning.

Various methods of identifying relevant results may be used. According to one embodiment, semantic search engine determines the similarity between the query vector (e.g., the semantically embedded input string) and a document text vector (a semantically embedded text chunk) and by computing a similarity score—for example, a cosine similarity—between the embeddings. Semantic search engine 106 can thus determine that the document text vector represents semantically relevant content based on the similarity score determined for the document text vector.

In one embodiment, semantic search engine 106 identifies a text chunk (e.g., a normalized text chunk) as semantically relevant to search query 200 if the text chunk is mapped to a semantically relevant document text vector in index 122. Similarly, semantic search engine 106 can identify the snippets that are mapped to a semantically relevant document text vector or text chunk as being semantically relevant snippets. For example, if a document text vector in index 122 is determined to be sufficiently like the query vector (e.g., based on similarity score), semantic search engine 106 can identify the snippets mapped to the document text vector in index 122 as semantically relevant to search query 200. Further, in some embodiments, semantic search engine identifies the documents associated with the semantically relevant snippets as documents that are semantically relevant to search query 200.

Semantic search engine 106 returns a semantic search result 209 to UI 104, which displays the semantic search result to the user (output 210). According to one embodiment, the semantic search result identifies documents from document corpus 102. For example, the semantic search result may include the document identifiers from the semantically relevant snippets.

According to one embodiment, semantic search result 209 includes citations, where a citation includes snippet information for a semantically relevant snippet. The snippet information for a semantically relevant snippet may include one or more of the snippet identifier, the original text chunk from the semantically relevant snippet, the document identifier from the semantically relevant snippet, the snippet offset, document metadata (e.g., Author or other metadata) of the document associated with the snippet. The snippet information may, in some embodiments, include the entire snippet. In some embodiments, a citation includes information such as, but not limited to, the semantically relevant normalized text chunk, a relevance score for the semantically normalized text chunk or snippet, or snippet information for snippets before or after a semantically relevant snippet.

The user may be given the option to perform another semantic search or another type of search (e.g., a lexical search using second search engine 110). According to one embodiment, the user is given an option to search within semantically relevant documents where the semantically relevant documents are the documents identified in semantic search result 209 or otherwise identified from the semantically relevant snippets. The user enters another search query, for example, a lexical search query 212. If the user selects to search within the results of the semantic search, UI 104 formulates a request 214 to second search engine 110 that includes the user's query parameters with constraints to limit the search or search results to the documents identified in semantic search results 209. For example, request 214 may include the document IDs included in the snippets returned in search result 209. Second search engine 110 searches document corpus 102, constraining the search results to the documents identified in request 214. Second search engine 110 returns a response 216 to UI 104 that includes the search results, which UI 104 displays to user 105 (output 218).

In some embodiments, a user may perform multiple searches in the context of a defined logical flow, such as a search session, conversation, or a dialog. According to one embodiment, if user 105 performs a first search and then, in the context of a defined logical flow, submits another search query, document analysis system 100 performs the new search within the scope of the documents returned by the prior search, even if the prior search was a different type of search. Thus UI 104 (or other component of document analysis system 100) can scope a new search to the documents referenced in prior search results, either automatically or based on user selection. The user can thus seamlessly switch between semantic search and other types of searches in a defined logical flow.

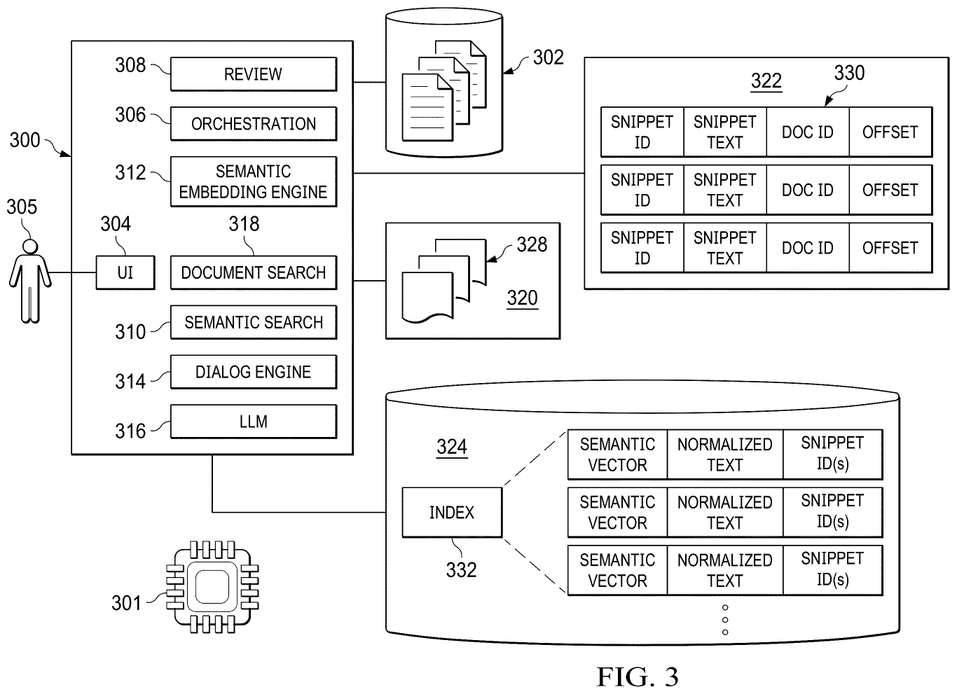

FIG. 3 is a diagrammatic representation of one embodiment of a document analysis system 300. Document analysis system 300 executes on a processor 301, which, in some embodiments, comprises a plurality of processors of a plurality of computers that execute code to provide a document analysis system. The code is embodied, in some embodiments, on a non-transitory, computer readable medium.

Document analysis system 300 supports various types of search technologies for searching a large corpus of documents 302. Document corpus 302 can comprise documents stored on a variety of storage technologies, including across heterogeneous storage technologies (e.g., stored on remote or local databases, remote or local file systems, cloud stores or other storage technologies). As will be appreciated, to support semantic search, documents may be embedded as vectors. Even more particularly, documents may be broken down into more manageable chunks and each chunk embedded as a vector.

In the embodiment illustrated, document analysis system 300 includes a user interface 304 through which a user 305 can interact with the system, a dialog orchestration engine 306, a review service 308, a semantic search engine 310, a semantic embedding engine 312, a dialog engine 314, an LLM 316, and a document search engine 318. According to one embodiment, document search engine 318 is a lexical search engine that searches on metadata fields and, in some systems, document content for literal matches of words, terms, phrases or variants to identify documents and returns the documents that meet the logical constraints specified in the search.

Document analysis system 300 includes a text store 320, a snippet store 322, and an embedding store 324 for storing data related to searching document corpus 302. Each of text store 320, snippet store 322, and embedding store 324 comprises a file system, a database, or other storage technologies or combinations thereof. While illustrated separately, two or more of text store 320, snippet store 322, or embedding store 324 may represent portions of the same data store.

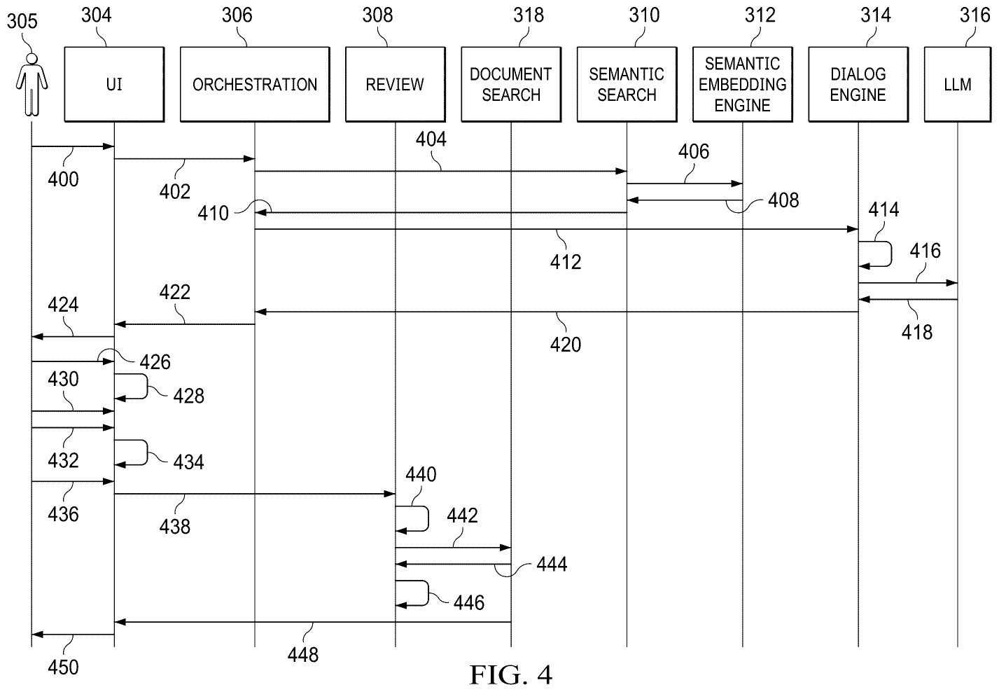

In some embodiments, one or more of semantic search engine 310, semantic embedding engine 312, or LLM 316 are provided by a third party. Further, document analysis system 300 may include additional or alternative services. Thus, for example, a request illustrated as flowing from one component to another in FIG. 4A or FIG. 4B below may be processed and conditioned by one or more intermediate services between the components.

User interface 304 allows user 305 to submit queries to dialog system 300 to search corpus 302 and to prompt generative AI (e.g., LLM 316) to perform various generative operations with respect to documents in document corpus 102 including, but not limited to, answering questions using content from document corpus 102. In some embodiments, user interface 304 supports different search technologies, including, for example, lexical searching and semantic searching, different semantic search engines or the like.

User interface 304 allows user 305 to submit queries for searching and generative AI. Document analysis system 300 can service quires in the context of prior search results. For example, document analysis system 300 may constrain a lexical search to the results of the semantic search. Thus, iterative searches may be performed in the context of prior searches.

In some embodiments, searches occur in the context of a dialog. Dialog orchestration service 306 manages dialogs and can combine responses from various components such as semantic search engine 310 and LLM 316. A dialog is a conversational context that is maintained to allow document analysis system 300 to accumulate state to disambiguate language that is syntactically ambiguous (e.g., what was “her” name) based on well-supported disambiguation elements such as named entities that are correctly implied by the context and not by the syntax. A dialog can comprise one or a sequence of dialog inputs and, in some embodiments, remembers outputs associated with the inputs. Thus, various inputs and outputs in a dialog are associated by a dialog ID. In other embodiments, there is no association between dialog inputs and outputs.

Document analysis system 300 applies retrieval augmented generation (RAG). RAG combines text generation with retrieval. RAG uses both semantic search to identify documents of interest and LLM 316 to generate text to answer a question, summarize information, or perform other tasks with respect to the documents. LLM 316 is trained on vast amounts of text to understand existing content and generates original content. Dialog engine 314 processes queries to generate prompts and context for input to LLM 316.

The text of searchable documents from document corpus 302 is stored in document analysis system 300 as index text 328 for the documents. According to one embodiment, the index text 328 for a document comprises a character array of characters from the document—for example, as a single dimensional character array in one embodiment.

To support semantic search, the documents from document corpus 302 may be semantically embedded as document text vectors that represent the document text for semantic searching. More particularly, the documents from document corpus 302 may be broken down into more manageable chunks of text, referred to herein as original text chunks, and the original text chunks semantically embedded as document text vectors. As discussed below, the process of semantically embedding an original text chunk may involve normalizing the original text chunk and semantically embedding the normalized text chunk as the document text vector representing the text chunk.

According to one embodiment, each of the original text chunks associated with a document is a sequence of characters within the index text 328 of a document. In an even more particular embodiment, an original text chunk is a single dimension aware sequence of characters within the index text 328 of a document. According to one embodiment, an original text chunk has a start offset and end offset within the character array of the index text 328 of a document. In some embodiments, the original text chunks follow a set of delineation rules, such as, but not limited to junk text is excluded, punctuation is preserved, capitalization is preserved. The amount of text in an original text chunk will depend on the chunking rules applied. According to one embodiment, the documents from document corpus 302 are chunked into defined grammatical units, such as sentences.

The original text chunks are stored as snippets 330 in snippet store 322. According to one embodiment, a snippet 330 comprises an original text chunk (snippet text), a document ID of a document from document corpus 302, and an offset in a document coordinate system indicating the location of the snippet text in the document (that is, the location of the snippet text in the document having the document ID with which the snippet is associated). A snippet may thus be an original text chunk in the context of a document. Each snippet 330 can be assigned a unique id according to one embodiment.

The snippet texts—that is the original text chunks—from snippets 330 are embedded as document text vectors for semantic search. Various text embedding models known or developed in the art can be used to embed snippets text as semantic vectors for semantic search. According to one embodiment, a multi-qa-mpnet-base-dot-v1 model is used to generate document text vectors. As discussed above, original text chunks may be normalized for embedding as document text vectors.

Embedding store 324 comprises a vector index 332 of snippets that associates the semantically embedded text chunks—that is, the document text vectors—with snippets. In a more particular embodiment, index 332 maps the document text vectors to normalized text chunks from which the document text vectors were generated and the snippets 330 from snippet store 322 that map to the normalized text chunks. Because the snippet text in multiple snippets may map to the same normalized text and hence semantic vector, multiple snippets 330 may map to the same normalized text chunk and document text vector in index 332.

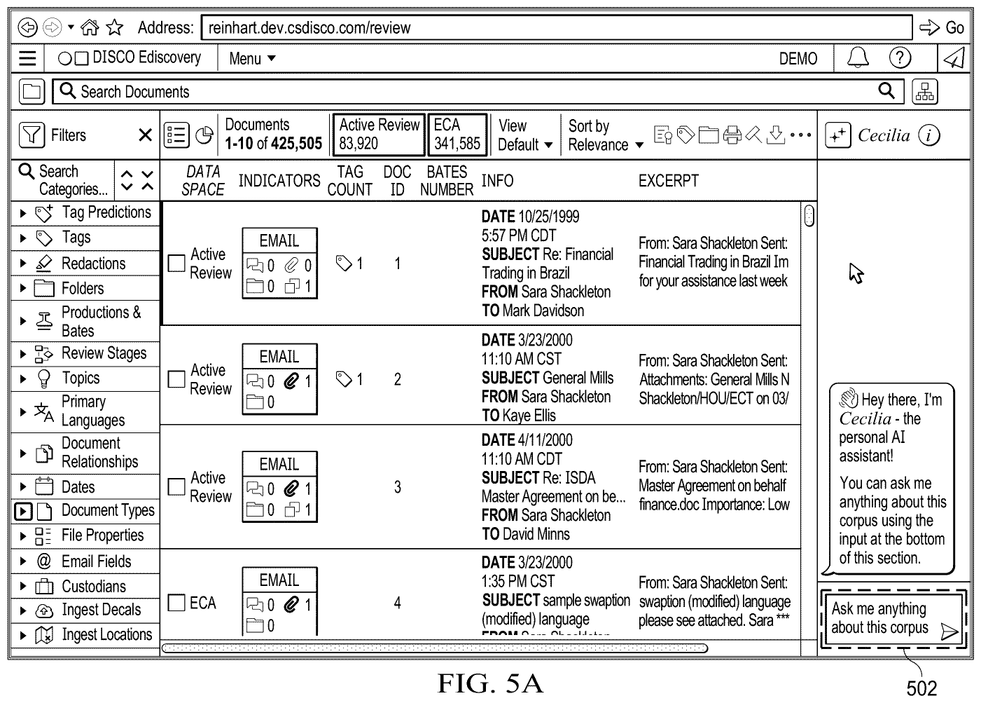

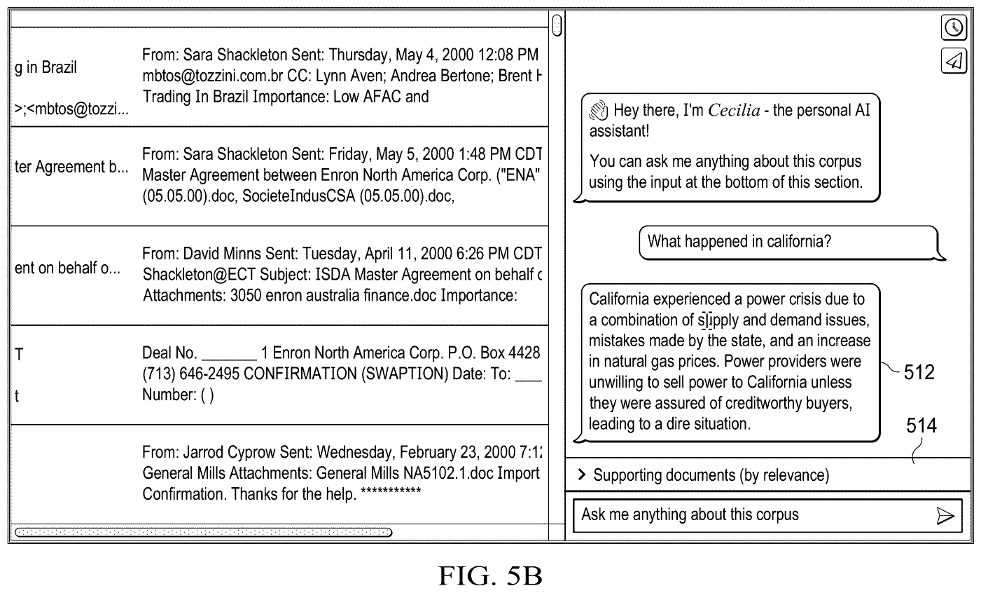

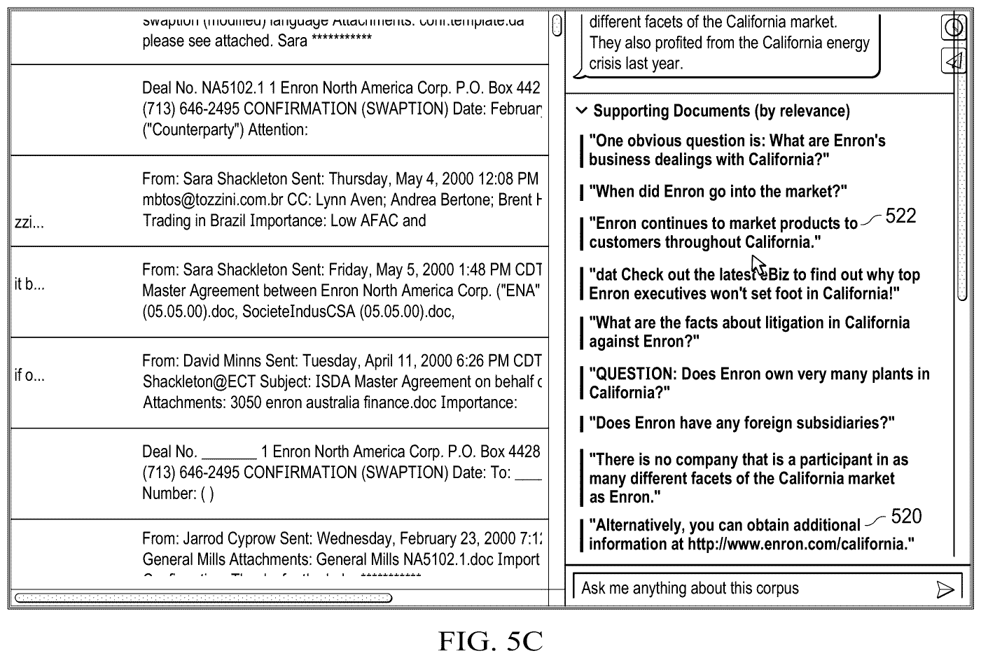

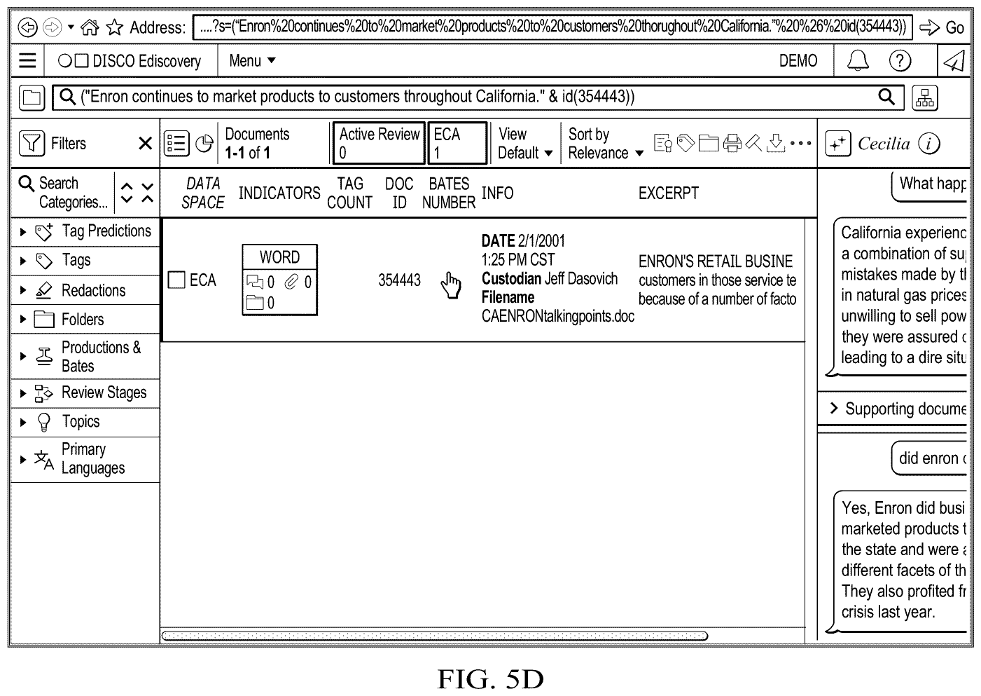

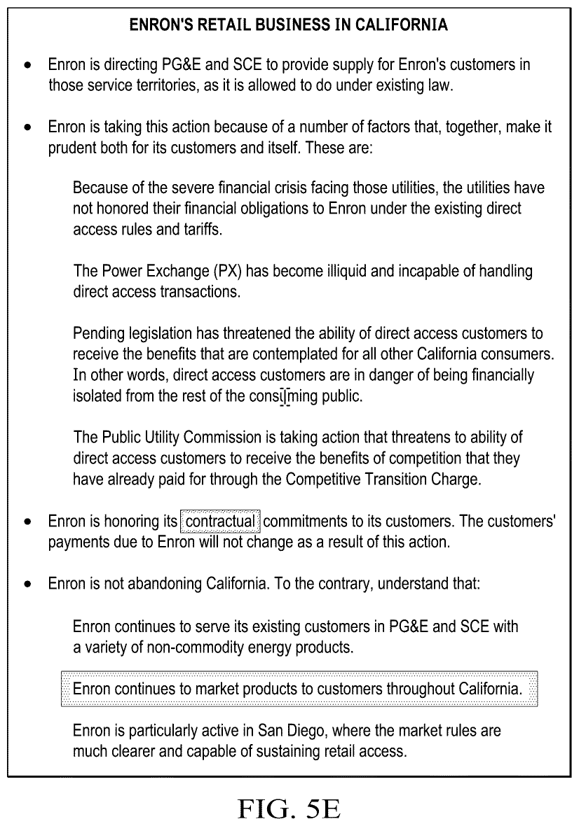

Turning to FIG. 4, one embodiment of a flow in document analysis system 300 is illustrated. User 305 accesses user interface 304 and submits a semantic search query 400, such as a natural language query. Turning briefly to FIG. 5A, one embodiment of a user-interface for searching a large corpus of documents is illustrated. Here, the user-interface includes a control 502 to allow a user to submit a natural language query. As an example, the query includes an input string such as “What happened in California?”

Returning to FIG. 4, user interface 304 thus receives a semantic search query 400. Document analysis system 300 services semantic search query 400 to return a response 422 that identifies documents from document corpus 302 that are semantically relevant to semantic search query 400. Response 422 may also include generative content generated by LLM 316.

UI 104 sends a request 402 to dialog orchestration engine 306 that includes the user input string. According to one embodiment, dialog orchestration engine 306 begins a dialog. Thus, in some embodiments, subsequent communications between components in FIG. 4 may include a dialog identifier for the dialog. Dialog orchestration engine 306 sends a search request 404 to semantic search engine 310 to find citations. The search request 404 includes the user input string (e.g., “What happened in California?”) and, in some embodiments, a dialog identifier. Semantic search engine 310 sends a request 406 to semantic embedding engine 312 to semantically embed the input string (e.g., “What happened in California?”) as a query vector.

According to one embodiment, semantic embedding engine 312 embeds the input string in the same way the original text chunks from the document of document corpus 302 were embedded, including normalizing the input string for embedding in the same manner as the original chunks were normalized for embedding. Semantic embedding engine 312 returns a response 408 to semantic search engine 310 that includes the query vector (that is, the semantically embedded (normalized) input string).

Semantic search engine 310 searches embedding store 324 using the embedded query string to identify relevant snippets. Non-limiting examples of semantically searching for relevant snippets are discussed above. Semantic search engine 310 returns a semantic search result 410 to dialog orchestration engine 306. According to one embodiment, the semantic search result identifies documents from document corpus 302. For example, the semantic search result may include the document identifiers from the semantically relevant snippets.

According to one embodiment, semantic search result 410 includes citations, where a citation includes snippet information for the semantically relevant snippets. The snippet information for a semantically relevant snippet may include one or more of the snippet identifier of a semantically relevant snippet, the original text chunk from the semantically relevant snippet, the document identifier from the semantically relevant snippet, the snippet offset, document metadata (e.g., Author or other metadata) of the document associated with the snippet. In some embodiments, the snippet information includes the entire snippet. In some embodiments, a citation includes information such as, but not limited to, the semantically relevant normalized text chunk, a relevance score for the semantically normalized text chunk or snippet, or snippet information for snippets before or after a semantically relevant snippet.

Dialog orchestration engine 306 generates a request 412 to dialog engine 314. The request 412 includes the search query string (e.g., “What happened in California?”) and the citations or snippets/snippet information from semantic search result 410. Dialog engine 314 generates a prompt and context for LLM 316 to answer the question entered by the user (indicated at 414). As will be appreciated, the prompt can be a prompt to answer the question entered by the user (e.g., in query 400). For example, the prompt may include “What happened in California?”) and the citations or snippet information returned in search result 410. In some embodiments, dialog engine 314 provides the citations or snippet text as context. In other embodiments, dialog engine 314 provides the entire text of each document from corpus 302 referenced in the citations (e.g., each document having a document id that is included in a snippet in a citation included in semantic search result 410). Thus, dialog engine 314 can formulate a prompt and content to prompt LLM 316 to answer a question using just the text from the normalized text chunks, snippets or documents that are semantically relevant to query 400. Some example prompts and associated context structures are provided in the attached code appendix.

Dialog engine 314 sends a request 416 to LLM 316 that includes the prompt and associated context. LLM 316 processes the prompt to generate text and returns a response 418 that includes generative text generated by answering the question using the provided constraints. In one embodiment, LLM 316 answers the question using the text included in request 416. As will be appreciated, LLM 316 may identify the snippets or documents on which it based its answer. Dialog engine 314 returns a response 420 to dialog orchestration engine 306 that includes the text generated by LLM 316. Dialog orchestration engine 306 sends a response 422 to UI 304 that includes the semantic search results 410 returned by semantic search engine 310 and the text generated by LLM 316. UI 304 displays a result 424 (e.g., the response text generated by LLM 316 and citations returned in semantic search result 410) to user 305.

As illustrated in FIG. 5B, for example, document analysis system 300 returns the text 512 generated by LLM 316. Thus, the flow can be repeated for any number of questions.

The user can click on the citation expand button 514 (input 426 of FIG. 4) and UI 304 updates the output (represented at 428) to display the list of snippets returned in the last answer (that is, the snippets returned in search result 422 with respect to the last question asked in the dialog). In some embodiments, UI 304 displays the snippets in relevance order. FIG. 5C, for example, illustrates the user interface with citations list 520 showing snippets.

The user can select one or more citations from the citations list (input 430 of FIG. 4). UI 304 updates a search input with the snippet text (e.g., sentences from the snippets) and document ids from the snippets of the selected citations (represented at 434). In some embodiments, UI 304 updates the search input with the snippet IDs from the selected citations in addition to or in lieu of the snippet text. The user commits the search (input 436). UI 304 generates a request to review service 308 that includes the snippet text and document ids from the selected citation(s). Review service 308 parses the request from UI 304 and generates a query (represented at 440 of FIG. 4). According to one embodiment, review service 308 generates a lexical search query. According to one embodiment, review service 308 generates an elastic search query. Review service 308 sends the search query 442 to document search engine 318 and document search engine 318 services the query to generate a response 444. In some embodiments, review service 308 enriches the results (represented at 446 in FIG. 4) and returns a response 448 to UI 304 that includes search results. UI 304 displays an updated result list 450 to user 305.

For example, if the user selects just snippet 522 in FIG. 5D, UI 304 can formulate a query with “Enron continues to market products to customers throughout California” & id(354443) (the original text chunk and doc id of the document from which the snippet was extracted). If the user clicks to run the search, UI 304 generates a request 438 to review service 308 that includes the snippet text and the document id from the selected citation. Review service 308 parses the request from UI 304 and generates a query to document search engine 318. According to one embodiment, review service 308 generates an elastic search query. Review service 308 sends the search query 442 to document search engine 318 and document search engine 318 returns the response 444 that includes results responsive to the query. In some embodiments, review service 308 enriches the results and returns a response 448, which displays an updated result list to user 305. Since the search is limited to one citation in this example, the search results will be the document that contained snippet 522.

One example of a search result list 450 is illustrated in FIG. 5D. The user can then select the document, and the document will be displayed with any snippets from the document that were returned in answer of step 422 highlighted, as illustrated, for example in FIG. 5E.

In addition to, or in the alternative to, allowing user 305 to select documents to review using citations (e.g., at input 430), UI 304 can provide a search tool to allow the user to search documents using other criteria. User 305 can thus enter a new search query 432. In such an embodiment, UI 304 updates the search input to include the document IDs from the citations selected by input 430, or automatically selected by UI 304, to limit the query to those documents. In some embodiments, UI 304 updates the search input to include the document ids from all the citations returned in search result 422. In some embodiments, UI 304 updates the search input to include the snippet text from the citations.

In any case, UI 304, at step 434, updates the search input to limit the search to returning only hits from those documents of corpus 302 that were included in the citations returned from the semantic search (potentially further limited by user selection). Thus, the search request 438 from UI 304 to review service 308 comprises the search criteria (e.g., lexical search criteria) provided by the user and the document IDs returned from the semantic search results. As such, the hits returned in response 448 and displayed to user 305 will be from the set of documents semantically related to the query 400, even if the search initiated by input 436 is not a semantic search.

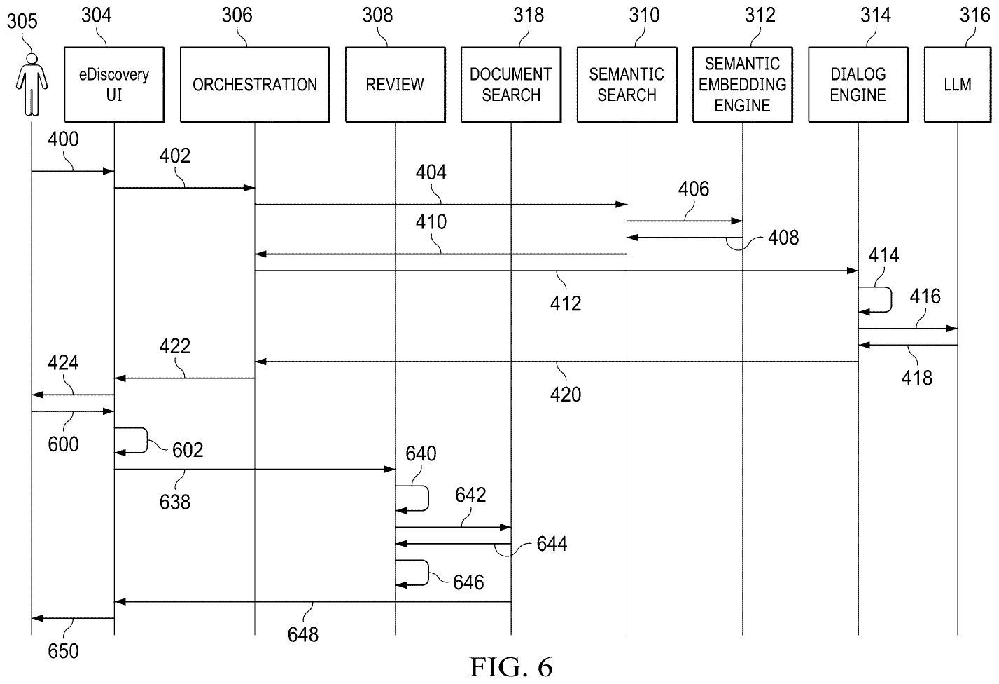

FIG. 6 illustrates another example embodiment of a flow in document analysis system 300. The flow of FIG. 6 is similar to that of FIG. 4, with UI 304 displaying a result 424 (e.g., the response text generated by LLM 316 and citations returned in semantic search result 410) to user 305. In this example, UI 304 provides one or more different types of search tools for further searching documents. For example, a user enters a lexical search input 600. In this example embodiment, UI 304 updates the search input (e.g., update 602) to constrain the search results to only the documents having document ids in the citations returned in response 422. In FIG. 6, the document ids are added to the search input in the background without user confirmation. In some embodiments, the user is provided the option to search within the documents returned in response to the semantic search or to search over the entire corpus when submitting the search input 600.

Thus, the search request 638 from UI 304 to review service 308 comprises the search criteria (e.g., lexical search criteria) provided by the user and the document IDs returned from the semantic search results from response 422. Review service 308 parses the request from UI 304 and generates a query (represented at 640 of FIG. 6). According to one embodiment, review service 308 generates an elastic search query. Review service 308 sends the search query 642 to document search engine 318 and document search engine 318 services the query to generate a response 644 the identifies documents responsive to search query 642. In some embodiments, review service 308 enriches the results (represented at 646 in FIG. 6) and returns a response 648 to UI 304 that includes search results for document search engine 318, possibly enriched by review service 308. UI 304 displays an updated result list 650 to user 305.

As such, the hits returned in response 648 and displayed to user 305 in the updated result list 650 will be from the set of documents semantically related to the query 400, even if the search initiated by search input 600 is not a semantic search.

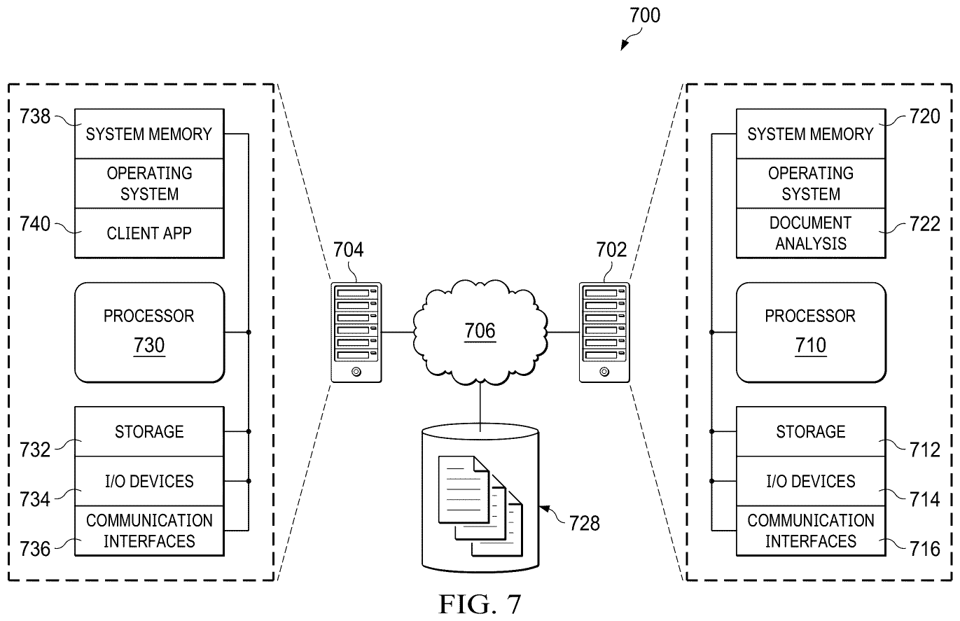

FIG. 7 is a diagrammatic representation of one embodiment of a computing environment 700 that includes a document analysis computer system 702 connected to a client system 704 via network 706.

Document analysis computer system 702 includes a processor 710 and memory 720. Depending on the exact configuration and type of mobile device, memory 720 (storing, among other things, executable instructions) may be volatile (such as RAM), non-volatile (such as ROM, flash memory, etc.), or some combination of the two. Further, Document analysis computer system 702 may also include storage devices 712, such as, but not limited to, solid state storage. Storage devices may provide storage for one or more of a document corpus, document index data, snippets, or a vector index. Similarly, document analysis computer system 702 may also have input device(s) and output device (I/O devices 714) such as keyboard, mouse, pen, voice input, touch screen, speakers. Document analysis computer system 702 further includes communications interfaces 716, such as a cellular interface, a Wi-Fi interface, or other interfaces.

Document analysis computer system 702 includes at least some form of non-transitory computer-readable media. The non-transitory computer-readable readable media can be any available media that can be accessed by processor 710 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, several program modules and data files may be stored in system memory 720. While executing on processor 710, program modules (e.g., applications, Input/Output (I/O) management, and other utilities) may perform processes including, but not limited to, one or more of the stages of the operational methods described with respect to document analysis 100 or document analysis system 300. In one embodiment, system memory 720 stores an operating system and a document analysis application 722. Document analysis application 722 is executable by processor 710 to provide a document analysis system that supports multiple types of searches of a document corpus 728 and can scope searches or LLM queries based on the results of a semantic search.

System memory 720 may include other program modules such as program modules to provide analytics or other services. Furthermore, the program modules may be distributed across computer systems in some embodiments.

Client system 704 includes a processor 730 and memory 738. Depending on the exact configuration and type of computer system, memory 738 (storing, among other things, executable instructions) may be volatile (such as RAM), non-volatile (such as ROM, flash memory, etc.), or some combination of the two. Further, client system 704 may also include storage devices 732. Similarly, client system 704 may also have input device(s) and output device (I/O devices 734) such as keyboard, mouse, pen, voice input, touch screen, speakers. Client system 704 further includes communications interfaces 736, such as a cellular interface, a Wi-Fi interface, or other interfaces.

Client system 704 includes at least some form of non-transitory computer-readable media. The non-transitory computer-readable readable media can be any available media that can be accessed by processor 730 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

Several program modules and data files may be stored in system memory 738. While executing on processor 730, program modules (e.g., applications, Input/Output (I/O) management, and other utilities) may perform processes to enable a user to interact with a document analysis system (e.g., as provided by document analysis application 722). In one embodiment, system memory 738 stores an operating system and a client application 740. Client application, according to one embodiment, is a desktop application for interacting with document analysis application 722. In one embodiment, client application 740 is a web browser. System memory 738 may include other program modules such as program modules to provide analytics or other services. Furthermore, the program modules may be distributed across computer systems in some embodiments.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

### APPENDIX

### WRITER:

context=‘\n’.join([f‘-{it.content.strip( )}’ for it in citations_included])
#context is in the form of new-line delimited sentences prefixed with ‘-’
prompt=(f″Input sentences:<input>\n″+
   f“{context}\n”+
   “</input>\n”+
   “Search the provided input sentences for the relevant information to answer the question.”+
   “Base your response only on the input sentences and substantiate any claim you make.”+
   “If there is not enough information to answer the question completely and clearly,”+
   “state: ‘Not enough suitable documents for an in-depth answer.’\n\n”+
   “Always answer in the past tense. Ensure that you can substantiate any claim you make.”+
   “In crafting your response, aim to provide answers that are not only accurate and based”+
   “solely on the provided input sentences, but also captivating, and enjoyable to read.”
   “Let your words enthrall the reader while maintaining adherence to the context of the given materials.”
   “If and only if the answer is not contained in the provided context, say only ‘I couldn't find a good answer.’”
   “Your answers should be delightful to read.\n\n”
   f“Question: {request.dialog_input}\n”+
   “Answer:”)

### AZURE (GPT)

context=‘.’.join([it.content for it in citations_included])
#context is in the form of a paragraph.. with sentences being joined with ‘.’
prompt=f‘Answer the following question using ONLY the provided context below.\n\n’+\
   f‘Question: {request.dialog_input}\n’+\
   f‘Context: {context}\n\n’+\
   ‘Answer the following question using ONLY the provided context. Answer the question accurately using ONLY the’+\
   ‘provided context. Be descriptive. Try to answer with at least two sentences. Do not reference specific times or’+\
   ‘date ranges unless requested. If the answer is not contained within the provided context, say only “I can\'t’+\
   ‘find it in the context”.\n\n’
   ‘Past-tense Answer:’

### FLAN

context=‘.’.join([it.content for it in citations_included])
#context is in the form of a paragraph.. with sentences being joined with ‘.’
prompt=f‘Answer based on Context: {context}\n\n’+\
   ‘Answer the following question using ONLY the provided context. Answer the question accurately using ONLY the’+\
   ‘provided context. Be descriptive. Try to answer with at least two sentences. Do not reference specific times or’+\
   ‘date ranges unless requested. If the answer is not contained within the provided context, say only “I can\'t’+\
   ‘find it in the context”.\n\n’
   f‘Questions: {request.dialog_input}\n’+\
   ‘Answer:’

What is claimed is:

1. A computer-implemented method for searching electronic documents, comprising:
receiving a semantic search query from a user to semantically search a document corpus;
servicing the semantic search query to return a first search result, the first search result identifying first documents from the document corpus that are determined to be semantically relevant to the semantic search query;
receiving a second search query from the user to perform a second type of search the document corpus; and
servicing the second search query to perform the second type of search scoped to the first documents to return a second search result.

2. The computer-implemented method of claim 1, wherein the second type of search is a lexical query.

3. The computer-implemented method of claim 1, further comprises:
providing the first search result to the user in a graphical user interface; and
receiving, via user interaction with the graphical user interface, an indication to scope the second type of search to the first documents.

4. The computer-implemented method of claim 1, further comprising automatically scoping the second type of search to the first documents.

5. The computer-implemented method of claim 1, wherein servicing the semantic search query comprises:
sending a request to a large language model, the request comprising a prompt to the large language model, the prompt comprising the semantic search query;
receiving generative text generated by the large language model in response to the prompt; and
including the generative text with the first search result.

6. The computer-implemented method of claim 5, wherein the request to the large language model includes context to constrain the large language model to the first documents when generating the generative text.

7. The computer-implemented method of claim 1, wherein the first search result comprises citations, the citations including chunks of text from the first documents.

8. A non-transitory, computer-readable medium storing thereon document analysis code executable by a processor, the document analysis code comprising instructions for:
receiving a semantic search query from a user to semantically search a document corpus;
servicing the semantic search query to return a first search result, the first search result identifying first documents from the document corpus that are determined to be semantically relevant to the semantic search query;
receiving a second search query from the user to perform a second type of search the document corpus; and
servicing the second search query to perform the second type of search scoped to the first documents to return a second search result.

9. The non-transitory, computer-readable medium of claim 8, wherein the second type of search is a lexical search.

10. The non-transitory, computer-readable medium of claim 8, wherein the document analysis code further comprises instructions for:
providing the first search result to the user in a graphical user interface; and
receiving, via user interaction with the graphical user interface, an indication to scope the second type of search to the first documents.

11. The non-transitory, computer-readable medium of claim 8, wherein the document analysis code further comprises instructions for:
automatically scoping the second type of search to the first documents.

12. The non-transitory, computer-readable medium of claim 8, wherein servicing the semantic search query comprises:
sending a request to a large language model, the request comprising a prompt to the large language model, the prompt comprising the semantic search query;
receiving generative text generated by the large language model in response to the prompt; and
including the generative text with the first search result.

13. The non-transitory, computer-readable medium of claim 12, wherein the request to the large language model includes context to constrain the large language model to the first documents when generating the generative text.

14. The non-transitory, computer-readable medium of claim 8, wherein the first search result comprises citations, the citations including chunks of text from the first documents.

15. A computer system proving enhanced search, the computer system comprising:
storage storing:
a plurality of snippets, each of the plurality of snippets comprising snippet text extracted from a document in a document corpus and a reference to the document from which the snippet text of that snippet was extracted;
an embedding store comprising a vector index of the plurality of snippets;
a processor;
a semantic search engine executable to perform semantic searching of the document corpus using the vector index;
a lexical search engine executable to perform lexical searching of the document corpus; and
a user interface, wherein the user interface is executable to scope lexical searches by the lexical search engine to documents identified in semantic search results from the semantic search engine.

16. The computer system of claim 15, wherein:
the semantic search engine is executable to:
search the vector index using an embedded query string from a first search input to identify, from the plurality of snippets, semantically relevant snippets that are semantically relevant to the first search input; and
return a corresponding semantic search result to the user interface, the corresponding semantic search result comprising document identifiers from the semantically relevant snippets, the document identifiers from the semantically relevant snippets identifying documents from the document corpus; and
the user interface is executable to generate a lexical search request to the lexical search engine to perform a corresponding lexical search, the lexical search request comprising search criteria input by a user and the document identifiers from the semantically relevant snippets to scope the corresponding lexical search to the documents identified by the document identifiers from the semantically relevant snippets.

17. The computer system of claim 16, wherein the user interface is executable to:
display the corresponding semantic search result to the user; and
receive, based on a user interaction with the user interface, an indication from the user to scope the corresponding lexical search to the documents identified by the document identifiers from the semantically relevant snippets.

18. The computer system of claim 17, wherein the corresponding semantic search result comprises a plurality of citations and wherein the indication to scope the corresponding lexical search comprises a selection of one or more citations from the plurality of citations, wherein each of the one or more citations corresponds to one of semantically relevant snippets.

19. The computer system of claim 18, wherein the user interface is executable to:
automatically scope the corresponding lexical search to the documents identified by the document identifiers from the semantically relevant snippets.

20. The computer system of claim 16, wherein the corresponding semantic search result comprises generative text generated by a large language model based on the semantically relevant snippets.
